(19) United States
(12) Patent Application Publication
(10) Pub. No.: US 2005/0281349 A1
(43) Pub. Date: Dec. 22, 2005

(54) Multiple streams using STBC with higher data rates and diversity gain within a wireless local area network

(75) Inventor: Joonsuk Kim, San Jose, CA (US)

Correspondence Address: SQUIRE, SANDERS & DEMPSEY L.L.P., 14TH FLOOR, 8000 TOWERS CRESCENT, TYSONS CORNER, VA, 22182, US

(73) Assignee: Brodcom Corporation

(21) Appl. No.: 10/995,402

(22) Filed: Nov. 24, 2004

Related U.S. Application Data
(60) Provisional application No. 60/581,429, filed on Jun. 21, 2004.

(51) Int. Cl. H04L 1/02

(52) U.S. Cl. 375/267

(57) ABSTRACT

A method of communicating data to M receiving antennas from N transmitting antennas, where M and N are integers, the method includes the steps of producing N data streams from outbound data, applying the N data streams to a space/time encoder to produce N encoded signals and transmitting the N encoded signals from N transmitting antennas. At least P transmitting antennas transmit space-time block-coded signals and (N-P) transmitting antennas transmit repetition code signals, where P is an integer. The transmission of the N encoded signals is performed such that the M receiving antennas receive at least three Orthogonal Frequency Division Multiplexing (OFDM) symbols per tone.

### REFERENCE TO RELATED APPLICATIONS

This application claims priority of U.S. Provisional Patent Application Ser. No. 60/581,429, filed Jun. 21, 2004. The subject matter of this earlier filed application is hereby incorporated by reference.

### BACKGROUND OF THE INVENTION

1. Technical Field of the Invention

This invention relates generally to wireless communication systems and more particularly to a transmitter transmitting at high data rates with such wireless communication systems. Additionally, the present invention allows the diversity of transmit streams and allows for an increase in the data rate.

2. Description of Related Art

Communication systems support wireless and wire lined communications between wireless and/or wire lined communication devices. Such communication systems range from national and/or international cellular telephone systems to the Internet to point-to-point in-home wireless networks. Each type of communication system is constructed, and hence operates, in accordance with one or more communication standards. For instance, wireless communication systems may operate in accordance with one or more standards including, but not limited to, IEEE 802.11, BLUETOOTH™, advanced mobile phone services (AMPS), digital AMPS, global system for mobile communications (GSM), code division multiple access (CDMA), local multi-point distribution systems (LMDS), multi-channel-multi-point distribution systems (MMDS), and/or variations thereof.

For each wireless communication device to participate in wireless communications, it may include a built-in radio transceiver (i.e., receiver and transmitter) or may be coupled to an associated radio transceiver (e.g., a station for in-home and/or in-building wireless communication networks, RF modem, etc.). The transmitter may include a data modulation stage, one or more intermediate frequency stages, and a power amplifier. The data modulation stage converts raw data into baseband signals in accordance with a particular wireless communication standard. The one or more intermediate frequency stages mix the baseband signals with one or more local oscillations to produce RF signals. The power amplifier amplifies the RF signals prior to transmission via an antenna.

The transmitter may include a data modulation stage, one or more intermediate frequency stages, and a power amplifier. The data modulation stage can convert raw data into baseband signals in accordance with a particular wireless communication standard. The one or more intermediate frequency stages mix the baseband signals with one or more local oscillations to produce RF signals. The power amplifier amplifies the RF signals prior to transmission via an antenna.

The transmitter includes at least one antenna for transmitting the RF signals, which are received by a single antenna, or multiple antennas, of a receiver. When the receiver includes two or more antennas, the receiver will select one of them to receive the incoming RF signals. In this instance, the wireless communication between the transmitter and receiver is a single-output-single-input (SOSI) communication, even if the receiver includes multiple antennas that are used as diversity antennas (i.e., selecting one of them to receive the incoming RF signals). For SISO wireless communications, a transceiver includes one transmitter and one receiver.

Other types of wireless communications include single-input-multiple-output (SIMO), multiple-input-single-output (MISO), and multiple-input-multiple-output (MIMO). In a SIMO wireless communication, a single transmitter processes data into radio frequency signals that are transmitted to a receiver. The receiver includes two or more antennas and two or more receiver paths. Each of the antennas receives the RF signals and provides them to a corresponding receiver path (e.g., LNA, down conversion module, filters, and ADCs). Each of the receiver paths processes the received RF signals to produce digital signals, which are combined and then processed to recapture the transmitted data.

For a multiple-input-single-output (MISO) wireless communication, the transmitter includes two or more transmission paths (e.g., digital to analog converter, filters, up-conversion module, and a power amplifier) that each converts a corresponding portion of baseband signals into RF signals, which are transmitted via corresponding antennas to a receiver. The receiver includes a single receiver path that receives the multiple RF signals from the transmitter. In this instance, the receiver uses beam forming to combine the multiple RF signals into one signal for processing.

For a multiple-input-multiple-output (MIMO) wireless communication, the transmitter and receiver each include multiple paths. In such a communication, the transmitter parallel processes data using a spatial and time encoding function to produce two or more streams of data. The transmitter includes multiple transmission paths to convert each stream of data into multiple RF signals. The receiver receives the multiple RF signals via multiple receiver paths that recapture the streams of data utilizing a spatial and time decoding function. The recaptured streams of data are combined and subsequently processed to recover the original data.

With the various types of wireless communications (e.g., SISO, MISO, SIMO, and MIMO), providing a diversity of transmitted signals is important to ensure proper data integrity. However, providing such diversity can limit the throughput of the transmission system. Therefore, a need exists for creating transmit diversity and data processing to utilize that diversity for such types of wireless communications without adversely affecting the data rate.

### BRIEF SUMMARY OF THE INVENTION

According to one embodiment of the present invention, a method of communicating data to M receiving antennas from N transmitting antennas, where M and N are integers, the method includes the steps of producing N data streams from outbound data, applying the N data streams to a space/time encoder to produce N encoded signals and transmitting the N encoded signals from N transmitting antennas. At least P transmitting antennas transmit space-time block-coded signals and (N-P) transmitting antennas transmit repetition code signals, where P is an integer.

Additionally, the step of transmitting the N encoded signals may be performed such that the M receiving antennas receive at least three Orthogonal Frequency Division Multiplexing (OFDM) symbols per tone. Also, when P is two and the step of transmitting the N encoded signals includes transmitting two space-time block-coded signals over two transmit antennas. Further, when N is three and the step of transmitting the N encoded signals includes transmitting a repetition code signal over one transmit antenna.

In addition, the step of applying the N data streams to a space/time encoder may be performed such that the outbound data is reconstituted by zero-forcing terms equivalent to relationships between signals sent from the N transmitting antennas to the M receiving antennas to cancel interference. In addition, the relationships may be represented by:

$$[ \begin{matrix}{r}_{1} \\ {r}_{2}\end{matrix} ] = [ \begin{matrix}{H}_{1} & {G}_{1} \\ {H}_{2} & {G}_{2}\end{matrix} ] [ \begin{matrix}{c}_{1} \\ {c}_{2}\end{matrix} ] + [ \begin{matrix}{n}_{1} \\ {n}_{2}\end{matrix} ] where , \\ {c}_{1} = [ \begin{matrix}{c}_{1} ( {t}_{0} ) \\ {c}_{1} ( {t}_{1} )\end{matrix} ] , {c}_{2} = [ {c}_{2} ( {t}_{0} ) ] , {r}_{1} = [ \begin{matrix}{r}_{1} ( {t}_{1} ) \\ {r}_{1}^{*} ( {t}_{2} )\end{matrix} ] , {r}_{2} = [ \begin{matrix}{r}_{2} ( {t}_{1} ) \\ {r}_{2}^{*} ( {t}_{2} )\end{matrix} ] , \\ {H}_{i} = [ \begin{matrix}{h}_{1 i} & {h}_{2 i} \\ {h}_{2 i}^{*} & - {h}_{1 i}^{*}\end{matrix} ] , {G}_{i} = [ \begin{matrix}{g}_{i} \\ {g}_{i}^{*}\end{matrix} ] ,$$

where rᵢ(t) and cᵢ(t) are the received and transmitted signals, respectively, nᵢ represent noise terms and Gᵢ and Hᵢ represent relationships between signals sent from the N transmitting antennas to the M receiving antennas.

According to another embodiment, a transmitter for communicating data from N transmitting antennas to M receiving antennas, where M and N are integers includes streaming means for producing N data streams from outbound data, encoding means for applying the N data streams to a space/time encoder to produce N encoded signals and N transmit antenna means for transmitting N encoded signals to M receiving antennas. The encoding means provides at least P space-time block-coded signals to P transmit antenna means and provides (N-P) repetition code signals to (N-P) transmit antennas, where P is an integer.

According to another embodiment, a transmitter for communicating data from N transmitting antennas to M receiving antennas, where M and N are integers includes a demultiplexer, configured to provide N data streams from outbound data, a space/time encoder, configured to receive the N data streams and supply N encoded signals and N transmit antennas, configured to transmit the N encoded signals. The space/time encoder provides at least P space-time block-coded signals to P transmit antenna means and provides (N-P) repetition code signals to (N-P) transmit antennas, where P is an integer.

### BRIEF DESCRIPTION OF THE DRAWINGS

For the present invention to be easily understood and readily practiced, the present invention will now be described, for purposes of illustration and not limitation, in conjunction with the following figures:

FIG. 1 is a schematic block diagram of a wireless communication device in accordance with one embodiment of the present invention;

FIG. 2 illustrates schematic block diagrams of a transmitter and receiver, with FIG. 2(a) providing a schematic block diagram of an RF transmitter and with FIG. 2(b) providing a schematic block diagram of an RF receiver, in accordance with embodiments of the present invention;

FIGS. 3(a) and 3(b) are a schematic block diagram of a transmitter in accordance one embodiment of with the present invention;

FIGS. 4(a) and 4(b) are a schematic block diagram of a receiver in accordance with one embodiment of the present invention;

FIG. 5 is a diagram illustrating a Space-Time Block Coding (STBC) method, in accordance with one embodiment of the present invention;

FIG. 6 is a diagram illustrating another Space-Time Block Coding (STBC) method used in channel estimation and communication of data, in accordance with one embodiment of the present invention;

FIG. 7 is a diagram of a transmitter configuration, in accordance with one embodiment of the present invention;

FIG. 8 provides a diagram of a packet structure, in accordance with one embodiment of the present invention;

FIG. 9 provides another diagram of a packet structure, in accordance with one embodiment of the present invention;

FIG. 10 provides a diagram of multiple transmit and multiple receive antennas, in accordance with one embodiment of the present invention;

FIG. 11 provides simulation results for bit error rates (BER) and packet error rates (PER) for 18 Mbps transmission, in accordance with one embodiment of the present invention;

FIG. 12 provides simulation results for bit error rates (BER) and packet error rates (PER) for 72 Mbps transmission, in accordance with one embodiment of the present invention;

### DETAILED DESCRIPTION OF THE PREFERRED EMBODIMENTS

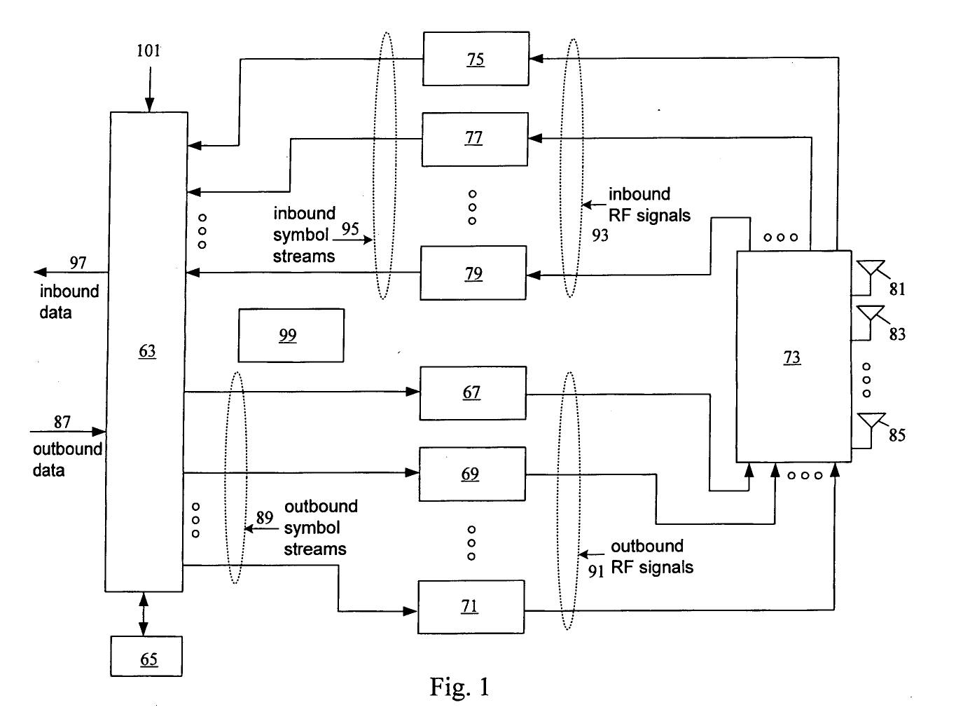

FIG. 1 is a schematic block diagram illustrating a wireless communication device, according to an example of the invention. The device includes a baseband processing module 63, memory 65, a plurality of radio frequency (RF) transmitters 67, 69, 71, a transmit/receive (T/R) module 73, a plurality of antennas 81, 83, 85, a plurality of RF receivers 75, 77, 79, and a local oscillation module 99. The baseband processing module 63, in combination with operational instructions stored in memory 65, execute digital receiver functions and digital transmitter functions, respectively. The digital receiver functions include, but are not limited to, digital intermediate frequency to baseband conversion, demodulation, constellation demapping, decoding, de-interleaving, fast Fourier transform, cyclic prefix removal, space and time decoding, and/or descrambling. The digital transmitter functions include, but are not limited to, scrambling, encoding, interleaving, constellation mapping, modulation, inverse fast Fourier transform, cyclic prefix addition, space and time encoding, and/or digital baseband to IF conversion. The baseband processing module 63 may be implemented using one or more processing devices. Such a processing device may be a microprocessor, micro-controller, digital signal processor, microcomputer, central processing unit, field programmable gate array, programmable logic device, state machine, logic circuitry, analog circuitry, digital circuitry, and/or any device that manipulates signals (analog and/or digital) based on operational instructions. The memory 66 may be a single memory device or a plurality of memory devices. Such a memory device may be a read-only memory, random access memory, volatile memory, non-volatile memory, static memory, dynamic memory, flash memory, and/or any device that stores digital information. Note that when the processing module 63 implements one or more of its functions via a state machine, analog circuitry, digital circuitry, and/or logic circuitry, the memory storing the corresponding operational instructions is embedded with the circuitry comprising the state machine, analog circuitry, digital circuitry, and/or logic circuitry.

In operation, the baseband processing module 63 receives the outbound data 87 and, based on a mode selection signal 101, produces one or more outbound symbol streams 89. The mode selection signal 101 will indicate a particular mode as are indicated in mode selection tables. For example, the mode selection signal 101 may indicate a frequency band of 2.4 GHz, a channel bandwidth of 20 or 22 MHz and a maximum bit rate of 54 megabits-per-second. In this general category, the mode selection signal will further indicate a particular rate ranging from 1 megabit-per-second to 54 megabits-per-second. In addition, the mode selection signal will indicate a particular type of modulation, which includes, but is not limited to, Barker Code Modulation, BPSK, QPSK, CCK, 16 QAM and/or 64 QAM. A code rate is supplied as well as number of coded bits per subcarrier (NBPSC), coded bits per OFDM symbol (NCBPS), data bits per OFDM symbol (NDBPS), error vector magnitude in decibels (EVM), sensitivity which indicates the maximum receive power required to obtain a target packet error rate (e.g., 10% for IEEE 802.11a), adjacent channel rejection (ACR), and an alternate adjacent channel rejection (AACR).

The mode selection signal may also indicate a particular channelization for the corresponding mode. The mode select signal may further indicate a power spectral density mask value. The mode select signal may alternatively indicate a rate that has a 5 GHz frequency band, 20 MHz channel bandwidth and a maximum bit rate of 54 megabits-per-second. As a further alternative, the mode select signal 101 may indicate a 2.4 GHz frequency band, 20 MHz channels and a maximum bit rate of 192 megabits-per-second. A number of antennas may be utilized to achieve the higher bandwidths. In this instance, the mode select would further indicate the number of antennas to be utilized. Another mode option may be utilized where the frequency band is 2.4 GHz, the channel bandwidth is 20 MHz and the maximum bit rate is 192 megabits-per-second. Various bit rates ranging from 12 megabits-per-second to 216 megabits-per-second utilizing 2-4 antennas and a spatial time encoding rate may be employed. The mode select signal 101 may further indicate a particular operating mode, which corresponds to a 5 GHz frequency band having 40 MHz frequency band having 40 MHz channels and a maximum bit rate of 486 megabits-per-second. The bit rate may range, in this example, from 13.5 megabits-per-second to 486 megabits-per-second utilizing 1-4 antennas and a corresponding spatial time code rate.

The baseband processing module 63, based on the mode selection signal 101 produces the one or more outbound symbol streams 89 from the output data 88. For example, if the mode selection signal 101 indicates that a single transmit antenna is being utilized for the particular mode that has been selected, the baseband processing module 63 will produce a single outbound symbol stream 89. Alternatively, if the mode select signal indicates 2, 3 or 4 antennas, the baseband processing module 63 will produce 2, 3 or 4 outbound symbol streams 89 corresponding to the number of antennas from the output data 88.

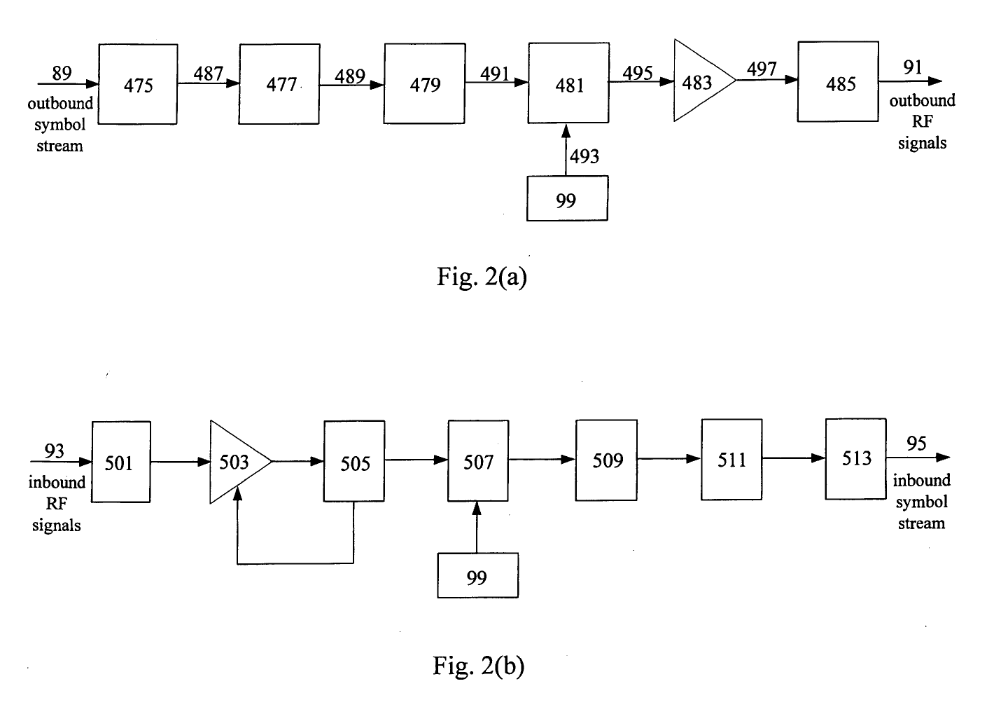

Depending on the number of outbound streams 89 produced by the baseband module 63, a corresponding number of the RF transmitters 67, 69, 71 can be enabled to convert the outbound symbol streams 89 into outbound RF signals 91. The implementation of the RF transmitters 67, 69, 71 will be further described with reference to FIG. 2. The transmit/receive module 73 receives the outbound RF signals 91 and provides each outbound RF signal to a corresponding antenna 81, 83, 85.

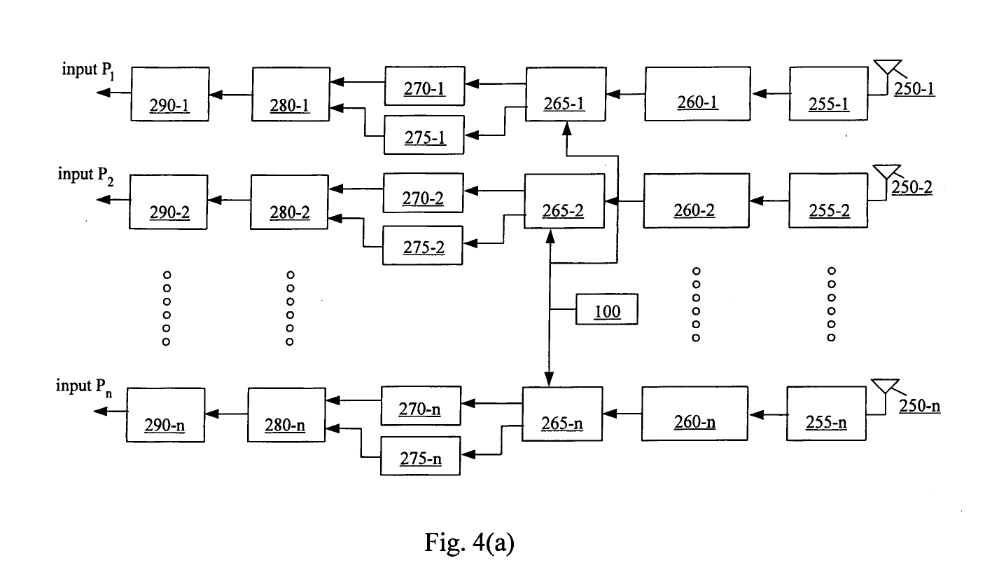

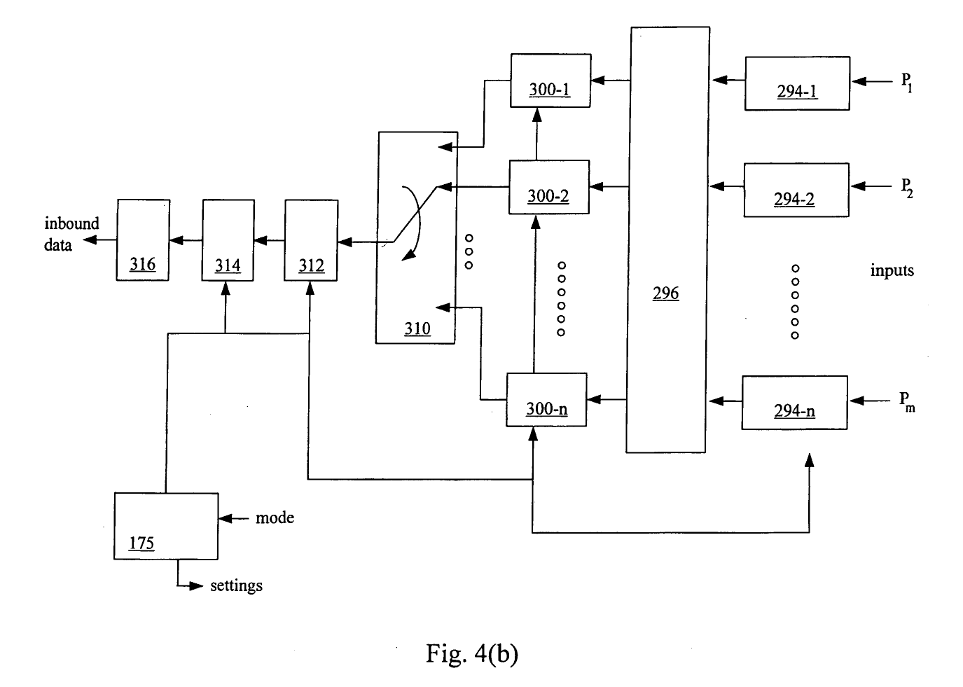

When the radio 60 is in the receive mode, the transmit/receive module 73 receives one or more inbound RF signals via the antennas 81, 83, 85. The T/R module 73 provides the inbound RF signals 93 to one or more RF receivers 75, 77, 79. The RF receiver 75, 77, 79, which will be described in greater detail with reference to FIG. 4, converts the inbound RF signals 93 into a corresponding number of inbound symbol streams 96. The number of inbound symbol streams 95 will correspond to the particular mode in which the data was received. The baseband processing module 63 receives the inbound symbol streams 89 and converts them into inbound data 97.

As one of average skill in the art will appreciate, the wireless communication device of FIG. 1 may be implemented using one or more integrated circuits. For example, the device may be implemented on one integrated circuit, the baseband processing module 63 and memory 65 may be implemented on a second integrated circuit, and the remaining components, less the antennas 81, 83, 85, may be implemented on a third integrated circuit. As an alternate example, the device may be implemented on a single integrated circuit.

FIG. 2(a) is a schematic block diagram of an embodiment of an RF transmitter 67, 69, 71. The RF transmitter may include a digital filter and up-sampling module 475, a digital-to-analog conversion module 477, an analog filter 479, and up-conversion module 81, a power amplifier 483 and a RF filter 485. The digital filter and up-sampling module 475 receives one of the outbound symbol streams 89 and digitally filters it and then up-samples the rate of the symbol streams to a desired rate to produce the filtered symbol streams 487. The digital-to-analog conversion module 477 converts the filtered symbols 487 into analog signals 489. The analog signals may include an in-phase component and a quadrature component.

The analog filter 479 filters the analog signals 489 to produce filtered analog signals 491. The up-conversion module 481, which may include a pair of mixers and a filter, mixes the filtered analog signals 491 with a local oscillation 493, which is produced by local oscillation module 99, to produce high frequency signals 495. The frequency of the high frequency signals 495 corresponds to the frequency of the RF signals 492.

The power amplifier 483 amplifies the high frequency signals 495 to produce amplified high frequency signals 497. The RF filter 485, which may be a high frequency band-pass filter, filters the amplified high frequency signals 497 to produce the desired output RF signals 91.

As one of average skill in the art will appreciate, each of the radio frequency transmitters 67, 69, 71 will include a similar architecture as illustrated in FIG. 2(a) and further include a shut-down mechanism such that when the particular radio frequency transmitter is not required, it is disabled in such a manner that it does not produce interfering signals and/or noise.

FIG. 2(b) is a schematic block diagram of each of the RF receivers 75, 77, 79. In this embodiment, each of the RF receivers may include an RF filter 501, a low noise amplifier (LNA) 503, a programmable gain amplifier (PGA) 505, a down-conversion module 507, an analog filter 509, an analog-to-digital conversion module 511 and a digital filter and down-sampling module 513. The RF filter 501, which may be a high frequency band-pass filter, receives the inbound RF signals 93 and filters them to produce filtered inbound RF signals. The low noise amplifier 503 amplifies the filtered inbound RF signals 93 based on a gain setting and provides the amplified signals to the programmable gain amplifier 505. The programmable gain amplifier further amplifies the inbound RF signals 93 before providing them to the down-conversion module 507.

The down-conversion module 507 includes a pair of mixers, a summation module, and a filter to mix the inbound RF signals with a local oscillation (LO) that is provided by the local oscillation module to produce analog baseband signals. The analog filter 509 filters the analog baseband signals and provides them to the analog-to-digital conversion module 511 which converts them into a digital signal. The digital filter and down-sampling module 513 filters the digital signals and then adjusts the sampling rate to produce the inbound symbol stream 95.

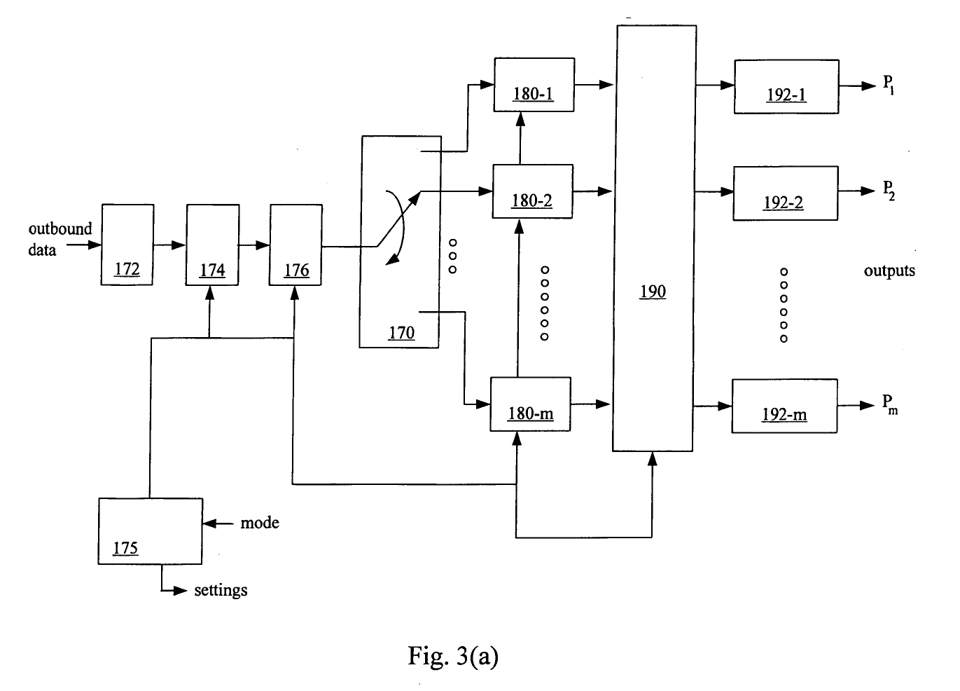

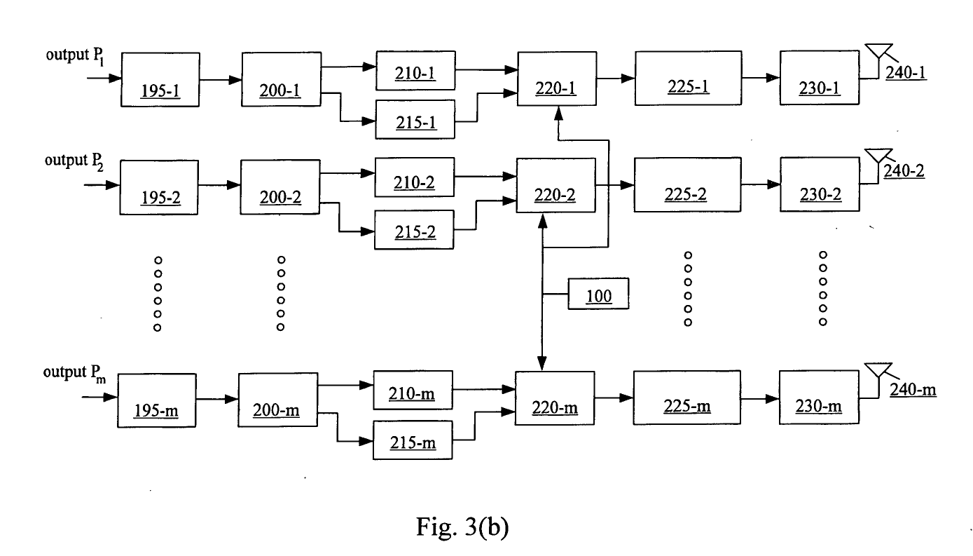

FIGS. 3(a) and 3(b) illustrate a schematic block diagram of a multiple transmitter in accordance with the present invention. In FIG. 3(a), the baseband processing is shown to include a scrambler 172, channel encoder 174, interleaver 176, demultiplexer 170, a plurality of symbol mappers 180-1 through 180-m, a space/time encoder 190 and a plurality of inverse fast Fourier transform (IFFT)/cyclic prefix addition modules 192-1 through 192-m. The baseband portion of the transmitter may further include a mode manager module 175 that receives the mode selection signal and produces settings for the radio transmitter portion and produces the rate selection for the baseband portion.

In operations, the scrambler 172 adds (in GF2) a pseudo random sequence to the outbound data bits 88 to make the data appear random. A pseudo random sequence may be generated from a feedback shift register with the generator polynomial, for example, of S(x)=x⁷+x⁴+1 to produce scrambled data. The channel encoder 174 receives the scrambled data and generates a new sequence of bits with redundancy. This will enable improved detection at the receiver. The channel encoder 174 may operate in one of a plurality of modes. For example, for backward compatibility with standards such as IEEE 802.11(a) and IEEE 802.11(g), the channel encoder has the form of a rate ½ convolutional encoder with 64 states and a generator polynomials of G₀=133₈ and G₁=171₈. The output of the convolutional encoder may be punctured to rates of ½, ⅔rds and ¾ according to the specified rate tables. For backward compatibility with IEEE 802.11(b) and the CCK modes of IEEE 802.11(g), the channel encoder has the form of a CCK code as defined in IEEE 802.11(b). For higher data rates, the channel encoder may use the same convolution encoding as described above or it may use a more powerful code, including a convolutional code with more states, a parallel concatenated (turbo) code and/or a low density parity check (LDPC) block code. Further, any one of these codes may be combined with an outer Reed Solomon code. Based on a balancing of performance, backward compatibility and low latency, one or more of these codes may be optimal.

The interleaver 176 receives the encoded data and spreads it over multiple symbols and transmit streams. This allows improved detection and error correction capabilities at the receiver. In one embodiment, the interleaver 176 will follow the IEEE 802.11(a) or (g) standard in the backward compatible modes. For higher performance modes, the interleaver will interleave data over multiple transmit streams. The demultiplexer 170 converts the serial interleave stream from interleaver 176 into M-parallel streams for transmission.

Each symbol mapper 180-m through 180-m receives a corresponding one of the M-parallel paths of data from the demultiplexer. Each symbol mapper locks maps bit streams to quadrature amplitude modulated QAM symbols (e.g., BPSK, QPSK, 16 QAM, 64 QAM, 256 QAM, et cetera) according to the rate tables. For IEEE 802.11(a) backward compatibility, double gray coding may be used.

The map symbols produced by each of the symbol mappers 180 are provided to the space/time encoder 190. Thereafter, output symbols are provided to the IFFT/cyclic prefix addition modules 192-1 through 192-m, which performs frequency domain to time domain conversions and adds a prefix, which allows removal of inter-symbol interference at the receiver. In general, a 64-point IFFT will be used for 20 MHz channels and 128-point IFFT will be used for 40 MHz channels.

In one embodiment, the number of M-input paths will equal the number of P-output paths. In another embodiment, the number of output paths P will equal M+1 paths. For each of the paths, the space/time encoder multiples the input symbols with an encoding matrix that has the form of:

$$[ \begin{matrix}{C}_{1} & {C}_{2} & {C}_{3} & … & {C}_{2 M - 1} \\ - {C}_{2}^{*} & {C}_{1}^{*} & {C}_{4} & … & {C}_{2 M}\end{matrix} ]$$

Note that the rows of the encoding matrix correspond to the number of input paths and the columns correspond to the number of output paths.

FIG. 3(b) illustrates the radio portion of the transmitter that includes a plurality of digital filter/up-sampling modules 195-1 through 195-m, digital-to-analog conversion modules 200-1 through 200-m, analog filters 210-1 through 210-m and 215-1 through 215-m, I/Q modulators 220-1 through 220-m, RF amplifiers 225-1 through 225-m, RF filters 230-1 through 230-m and antennas 240-1 through 240-m. The P-outputs from the other stage are received by respective digital filtering/up-sampling modules 195-1 through 195-m.

In operation, the number of radio paths that are active correspond to the number of P-outputs. For example, if only one P-output path is generated, only one of the radio transmitter paths will be active. As one of average skill in the art will appreciate, the number of output paths may range from one to any desired number.

The digital filtering/up-sampling modules 195-1 through 195-m filter the corresponding symbols and adjust the sampling rates to correspond with the desired sampling rates of the digital-to-analog conversion modules 200. The digital-to-analog conversion modules 200 convert the digital filtered and up-sampled signals into corresponding in-phase and quadrature analog signals. The analog filters 210 and 215 filter the corresponding in-phase and/or quadrature components of the analog signals, and provide the filtered signals to the corresponding I/Q modulators 220. The I/Q modulators 220 based on a local oscillation, which is produced by a local oscillator 100, up-converts the I/Q signals into radio frequency signals. The RF amplifiers 225 amplify the RF signals which are then subsequently filtered via RF filters 230 before being transmitted via antennas 240.

FIGS. 4(a) and 4(b) illustrate a schematic block diagram of another embodiment of a receiver in accordance with the present invention. FIG. 4(a) illustrates the analog portion of the receiver which includes a plurality of receiver paths. Each receiver path includes an antenna 250-1 through 250-n, RF filters 255-1 through 255-n, low noise amplifiers 260-1 through 260-n, I/O demodulators 265-1 through 265-n, analog filters 270-1 through 270-n and 275-1 through 275-n, analog-to-digital converters 280-1 through 280-n and digital filters and down-sampling modules 290-1 through 290-n.

In operation, the antennas 250 receive inbound RF signals, which are band-pass filtered via the RF filters 255. The corresponding low noise amplifiers 260 amplify the filtered signals and provide them to the corresponding I/Q demodulators 265. The I/Q demodulators 265, based on a local oscillation, which is produced by local oscillator 100, down-converts the RF signals into baseband in-phase and quadrature analog signals.

The corresponding analog filters 270 and 275 filter the in-phase and quadrature analog components, respectively. The analog-to-digital converters 280 convert the in-phase and quadrature analog signals into a digital signal. The digital filtering and down-sampling modules 290 filter the digital signals and adjust the sampling rate to correspond to the rate of the baseband processing, which will be described in FIG. 4(b).

FIG. 4(b) illustrates the baseband processing of a receiver. The baseband processing portion includes a plurality of fast Fourier transform (FFT)/cyclic prefix removal modules 294-1 through 294-n, a space/time decoder 296, a plurality of symbol demapping modules 300-1 through 300-n, a multiplexer 310, a deinterleaver 312, a channel decoder 314, and a descramble module 316. The baseband processing module may further include a mode managing module 175. The receiver paths are processed via the FFT/cyclic prefix removal modules 294 which perform the inverse function of the IFFT/cyclic prefix addition modules 192 to produce frequency domain symbols as M-output paths. The space/time decoding module 296, which performs the inverse function of space/time encoder 190, receives the M-output paths.

The symbol demapping modules 300 convert the frequency domain symbols into data utilizing an inverse process of the symbol mappers 180. The multiplexer 310 combines the demapped symbol streams into a single path.

The deinterleaver 312 deinterleaves the single path utilizing an inverse function of the function performed by interleaver 176. The deinterleaved data is then provided to the channel decoder 314 which performs the inverse function of channel encoder 174. The descrambler 316 receives the decoded data and performs the inverse function of scrambler 172 to produce the inbound data 98.

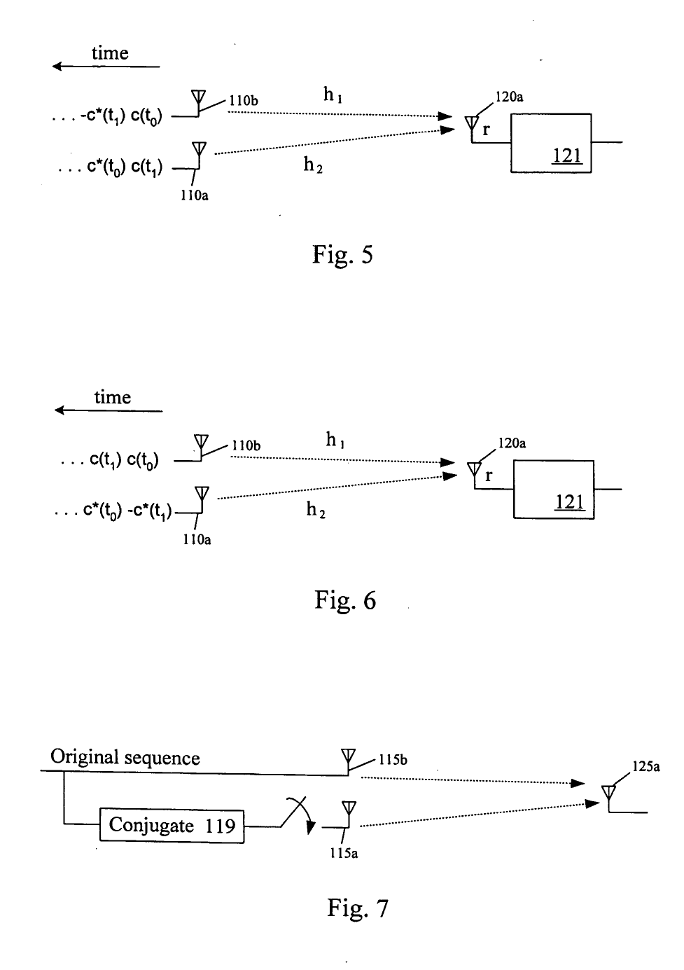

FIG. 5 is a basic diagram illustrating one embodiment of STBC realization or transmission by the receiver 121. In this embodiment, a first antenna 110b of a transmitting device transmits a first complex training signal (e.g.,−c*(t₁) c(t₀), where c(t) represents a long training sequence and “*” represents a conjugate function) and a second antenna 110a of the transmitting device transmits a second complex training signal (e.g., c*(t₀) c(t₁)).

The receiver 121 receives the complex training signals, which is represented by “r”. For data processing, “r” may be expressed as:

$$[ \begin{matrix}r ( {t}_{0} ) \\ {r}^{*} ( {t}_{1} )\end{matrix} ] = [ \begin{matrix}{h}_{1} & {h}_{2} \\ {h}_{2}^{*} & - {h}_{1}^{*}\end{matrix} ] [ \begin{matrix}c ( {t}_{0} ) \\ c ( {t}_{1} )\end{matrix} ] + [ \begin{matrix}{n}_{1} \\ {n}_{2}\end{matrix} ] \qquad ( 1 )$$

For channel estimation, this equation may be written as:

$$[ \begin{matrix}r ( {t}_{0} ) \\ r ( {t}_{1} )\end{matrix} ] = [ \begin{matrix}c ( {t}_{0} ) & c ( {t}_{1} ) \\ - {c}^{*} ( {t}_{1} ) & {c}^{*} ( {t}_{0} )\end{matrix} ] [ \begin{matrix}{h}_{1} \\ {h}_{2}\end{matrix} ] + [ \begin{matrix}{n}_{1} \\ {n}_{2}\end{matrix} ] = C \times [ \begin{matrix}{h}_{1} \\ {h}_{2}\end{matrix} ] + [ \begin{matrix}{n}_{1} \\ {n}_{2}\end{matrix} ] \qquad ( 2 )$$

From this equation, the channel may be estimated using STBC, which can be expressed as:

$$[ \begin{matrix}{\tilde{h}}_{1} \\ {\tilde{h}}_{2}\end{matrix} ] = {C}^{*} \times [ \begin{matrix}r ( {t}_{0} ) \\ r ( {t}_{1} )\end{matrix} ] = [ \begin{matrix}{\sum }_{i = 1}^{2} {\vert c ( {t}_{i} ) \vert}^{2} & 0 \\ 0 & {\sum }_{i = 1}^{2} {\vert c ( {t}_{i} ) \vert}^{2}\end{matrix} ] \times [ \begin{matrix}{h}_{1} \\ {h}_{2}\end{matrix} ] + [ \begin{matrix}{\tilde{n}}_{1} \\ {\tilde{n}}_{2}\end{matrix} ] . \qquad ( 3 )$$

When the training sequence, i.e., c(t), in a Long Training Sequence (LTS) is known, h₁ and h₂ can be found from equation (3).

FIG. 6 is a basic diagram illustrating another embodiment of STBC realization or transmission by the receiver 121. In this embodiment, a first antenna 110b of a transmitting device transmits a first complex training signal (e.g.,c(t₁) c(t₀), where c(t) represents a long training sequence and “*” represents a conjugate function) and a second antenna 110a of the transmitting device transmits a second complex training signal (e.g., c*(t₀)−c*(t₁)).

The receiver 121 receives the complex training signals, which is represented by “r”. For channel estimation, “r” may be expressed as:

$$[ \begin{matrix}r ( {t}_{0} ) \\ r ( {t}_{1} )\end{matrix} ] = [ \begin{matrix}c ( {t}_{0} ) & - {c}^{*} ( {t}_{1} ) \\ c ( {t}_{1} ) & {c}^{*} ( {t}_{0} )\end{matrix} ] [ \begin{matrix}{h}_{1} \\ {h}_{2}\end{matrix} ] + [ \begin{matrix}{n}_{1} \\ {n}_{2}\end{matrix} ] = C \times [ \begin{matrix}{h}_{1} \\ {h}_{2}\end{matrix} ] + [ \begin{matrix}{n}_{1} \\ {n}_{2}\end{matrix} ] . \qquad ( 4 )$$

From this equation, the channel may be estimated using STBC, which can be expressed as:

$$[ \begin{matrix}{\tilde{h}}_{1} \\ {\tilde{h}}_{2}\end{matrix} ] = {C}^{*} \times [ \begin{matrix}r ( {t}_{0} ) \\ r ( {t}_{1} )\end{matrix} ] = [ \begin{matrix}{\sum }_{i = 1}^{2} {\vert c ( {t}_{i} ) \vert}^{2} & 0 \\ 0 & {\sum }_{i = 1}^{2} {\vert c ( {t}_{i} ) \vert}^{2}\end{matrix} ] \times [ \begin{matrix}{h}_{1} \\ {h}_{2}\end{matrix} ] + [ \begin{matrix}{\tilde{n}}_{1} \\ {\tilde{n}}_{2}\end{matrix} ] . \qquad ( 5 )$$

When the training sequence, i.e., c(t), in the Long Training Sequence (LTS) is known, h₁ and h₂ can be found from equation (5).

The receiver 121 receives the complex signals, which is represented by “r”. The equation of “r” may be expressed as:

$$[ \begin{matrix}r ( {t}_{0} ) \\ {r}^{*} ( {t}_{1} )\end{matrix} ] = [ \begin{matrix}{h}_{1} & - {h}_{2} \\ {h}_{2}^{*} & {h}_{1}^{*}\end{matrix} ] [ \begin{matrix}c ( {t}_{0} ) \\ {c}^{*} ( {t}_{1} )\end{matrix} ] + [ \begin{matrix}{n}_{1} \\ {n}_{2}\end{matrix} ] = H \times [ \begin{matrix}c ( {t}_{0} ) \\ {c}^{*} ( {t}_{1} )\end{matrix} ] + [ \begin{matrix}{n}_{1} \\ {n}_{2}\end{matrix} ] \qquad ( 6 )$$

By keeping c(t₀), but conjugate on c*(t₁), after STBC decoding, yields:

$$[ \begin{matrix}\tilde{c} ( {t}_{0} ) \\ {\tilde{c}}^{*} ( {t}_{1} )\end{matrix} ] = {H}^{*} \times [ \begin{matrix}r ( {t}_{0} ) \\ {r}^{*} ( {t}_{1} )\end{matrix} ] = [ \begin{matrix}{\sum }_{i = 1}^{2} {\vert {h}_{i} \vert}^{2} & 0 \\ 0 & {\sum }_{i = 1}^{2} {\vert {h}_{i} \vert}^{2}\end{matrix} ] \times [ \begin{matrix}c ( {t}_{0} ) \\ {c}^{*} ( {t}_{1} )\end{matrix} ] + [ \begin{matrix}{\tilde{n}}_{1} \\ {\tilde{n}}_{2}\end{matrix} ] \qquad ( 7 )$$

FIG. 7 is a simplified diagram of the transmitter 160 to produce the first and second complex signals of FIGS. 5 and 6. With the conjugate function 119 being selectable, the transmitter may operate in a variety of modes. For example, when the switch is opened, the transmitter operates as a legacy IEEE 802.11a and 802.11g, i.e. “11a/g”, transmitter. When the switch is closed, the transmitter operates with STBC. As such, the transmitter can be chosen to be legacy system or STBC system by external switch.

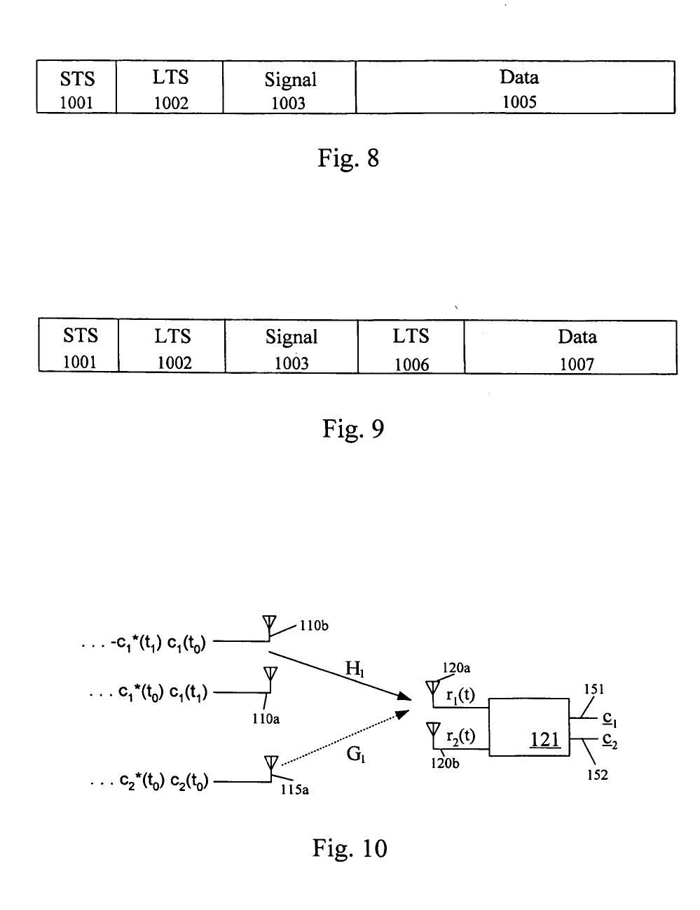

FIG. 8 is a diagram of a packet structure when the switch is open (i.e., the transmitter is acting as a legacy transmitter). In this mode, a 11a/g legacy receiver can receive the packet. Further, STBC compliant receivers can detect Short Training Sequence (STS) 1001 and know there is one transmit antenna (detect legacy mode), then process the packet, bypassing STBC mode. The preamble also includes a Long Training Sequence (LTS) 1002, a signal 1003 and data 1005. The STS is used for signal detection and frequency offset estimation and the LTS is used for channel estimation. Still further, both a 11a/g legacy receiver and a STBC compliant receiver can receive the legacy 11a/g packet.

FIG. 9 is a diagram of a packet structure when the switch is closed (i.e., the transmitter is using the STBC). In this mode, STS 1001 is cyclic shifted per each transmit antenna. The MAC (firmware) of transmitter can add LTS 1006 in front of Data 1007 for the packet. Further, an STBC compliant receiver can detect STS (or 2nd LTS after Signal), and know there are two transmit antennas, then process the packet with STBC mode.

FIG. 10 is a schematic diagram of a WLAN communication that includes three transmit antennas and two receive antennas, according to one embodiment of the instant invention. To utilize STBC (space time block coding), a flat channel response is desired. To achieve this, OFDM for frequency selective channels is employed. In this mode, the first transmit antenna pairs will have STBC, while the third transmit antenna will have repetition codes with conjugate.

In FIG. 10, multiple signals, c₁(t) and c₂(t), are received from an encoding block. After coding, signal c₁ is transmitted through transmission antennas 110a and 110b, and signal c₂ is transmitted through transmission antenna 115a. The signal c₁ can be configured as illustrated in FIG. 5 or FIG. 6, and discussed above, and signal c₂ is encoded by repetition coding. The transmitted signals are received by the STBC decoding block 121, through receive antennas 120a and 120b. After processing, signals, c₁, and c₂, based on the originally transmitted signals are reformulated and output through outputs 151 and 152. In general, the received signal is related to the source signal through an “H” or “G” component plus a noise term.

From this set-up, the channels may be estimated as:

$${[ \begin{matrix}{r}_{1} \\ {r}_{2}\end{matrix} ]}_{4 x1} = {{[ \begin{matrix}{H}_{1} & {G}_{1} \\ {H}_{2} & {G}_{2}\end{matrix} ]}_{4 x3} [ \begin{matrix}{c}_{1} \\ {c}_{2}\end{matrix} ]}_{3 x1} + {[ \begin{matrix}{n}_{1} \\ {n}_{2}\end{matrix} ]}_{4 x1} where , \\ {c}_{1} = [ \begin{matrix}{c}_{1} ( {t}_{0} ) \\ {c}_{1} ( {t}_{1} )\end{matrix} ] , {c}_{2} = [ {c}_{2} ( {t}_{0} ) ] , {r}_{1} = [ \begin{matrix}{r}_{1} ( {t}_{1} ) \\ {r}_{1}^{*} ( {t}_{2} )\end{matrix} ] , {r}_{2} = [ \begin{matrix}{r}_{2} ( {t}_{1} ) \\ {r}_{2}^{*} ( {t}_{2} )\end{matrix} ] , \\ {H}_{i} = [ \begin{matrix}{h}_{1 i} & {h}_{2 i} \\ {h}_{2 i}^{*} & - {h}_{1 i}^{*}\end{matrix} ] , {G}_{i} = [ \begin{matrix}{g}_{i} \\ {g}_{i}^{*}\end{matrix} ] \qquad ( 8 )$$

To cancel the interference, zero forcing is applied such that:

$$\begin{matrix}\begin{matrix}{[ \begin{matrix}[ \begin{matrix}1 & 0 \\ 0 & 1\end{matrix} ] & [ \begin{matrix}- {g}_{1} {g}_{2}^{- 1} & 0 \\ 0 & - {g}_{1}^{*} {g}_{2}^{- 1 *}\end{matrix} ] \\ a b & c d\end{matrix} ]}_{3 \times 4} \times [ \begin{matrix}{r}_{1} \\ {r}_{2}\end{matrix} ] = [ \begin{matrix}{\tilde{r}}_{1} \\ {\tilde{r}}_{2}\end{matrix} ] \\ = {[ \begin{matrix}\tilde{H} & 0 \\ 0 & \tilde{G}\end{matrix} ]}_{3 \times 3} \times [ \begin{matrix}{c}_{1} \\ {c}_{2}\end{matrix} ] + \\ [ \begin{matrix}{\tilde{n}}_{1} \\ {\tilde{n}}_{2}\end{matrix} ]\end{matrix} \\ \begin{matrix}where , {\tilde{H}}_{2 \times 2} = {H}_{1} - [ \begin{matrix}- {g}_{1} {g}_{2}^{- 1} & 0 \\ 0 & - {g}_{1}^{*} {g}_{2}^{- 1 *}\end{matrix} ] \times {H}_{2} , & {\tilde{G}}_{1 \times 1} = {\vert {g}_{1} \vert}^{2} + {\vert {g}_{2} \vert}^{2} ,\end{matrix}\end{matrix} \qquad ( 9 )$$

and a, b, c, d satisfy the following equation:

$$[ \begin{matrix}a \\ b \\ c \\ d\end{matrix} ] = {[ \begin{matrix}{h}_{11} & {h}_{21}^{*} & {h}_{12} & {h}_{22}^{*} \\ {h}_{21} & - {h}_{11}^{*} & {h}_{22} & - {h}_{12}^{*} \\ {g}_{1} & {g}_{1}^{*} & 0 & 0 \\ 0 & 0 & {g}_{2} & {g}_{2}^{*}\end{matrix} ]}^{- 1} \times [ \begin{matrix}0 \\ 0 \\ {\vert {g}_{1} \vert}^{2} \\ {\vert {g}_{2} \vert}^{2}\end{matrix} ] \qquad ( 10 )$$

Next, STBC decoding may be performed with channel matching such that

$$[ \begin{matrix}{\tilde{H}}^{*} & \begin{matrix}0 \\ 0\end{matrix} \\ \begin{matrix}0 & 0\end{matrix} & {\tilde{G}}^{*}\end{matrix} ] [ \begin{matrix}{\tilde{r}}_{1} \\ {\tilde{r}}_{2}\end{matrix} ] = [ \begin{matrix}{\tilde{H}}^{*} \tilde{H} & \begin{matrix}0 \\ 0\end{matrix} \\ \begin{matrix}0 & 0\end{matrix} & {\tilde{G}}^{*} \tilde{G}\end{matrix} ] [ \begin{matrix}{c}_{1} \\ {c}_{2}\end{matrix} ] + [ \begin{matrix}{N}_{1} \\ {N}_{2}\end{matrix} ] \\ where , {\tilde{H}}^{*} \tilde{H} = {( {H}_{1} - [ \begin{matrix}- {g}_{1} {g}_{2}^{- 1} & 0 \\ 0 & - {g}_{1}^{*} {g}_{2}^{- 1 *}\end{matrix} ] \times {H}_{2} )}^{*} ( {H}_{1} - [ \begin{matrix}- {g}_{1} {g}_{2}^{- 1} & 0 \\ 0 & - {g}_{1}^{*} {g}_{2}^{- 1 *}\end{matrix} ] \times {H}_{2} ) , \\ {\tilde{G}}^{*} \tilde{G} = {( {\vert {g}_{1} \vert}^{2} + {\vert {g}_{2} \vert}^{2} )}^{2} , \qquad ( 11 )$$

which is diagonalized and constant x identity.

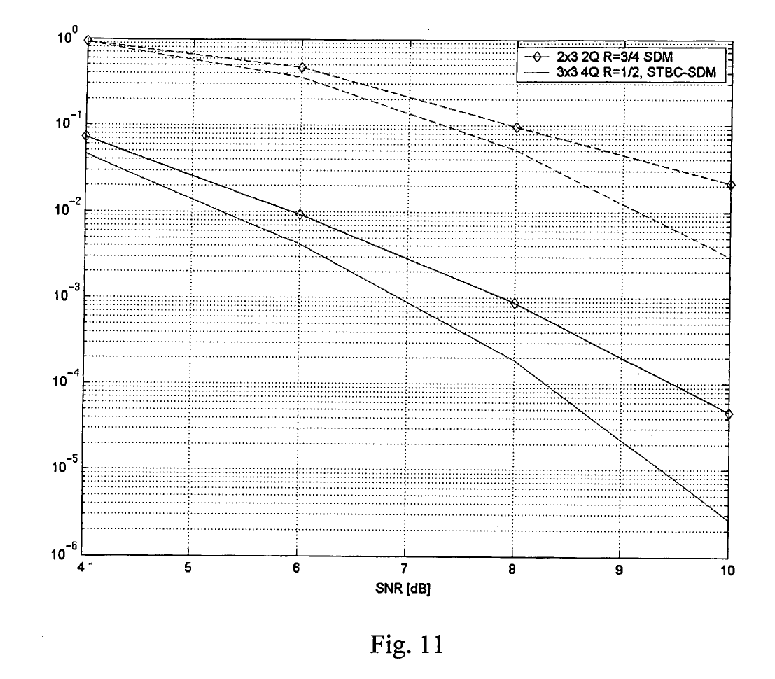

A substantial advantage of the present invention is that both of transmit streams will have transmit diversity over three antennas. That is, one stream is covered by STBC (space-time-block-coding), and the other stream is covered by repetition coding. Therefore, three symbols (two for STBC and one for repetition coding) are transmitted over three antennas in two time intervals, which results in data rate increase, when compared to prior art systems, of as much as 3/2=1.5 times. As illustrated in FIG. 11, the first transmit pairs use STBC (c₁(t₀) and c₁(t₁)) and the last transmit antenna uses repetition codes (c₂(t₀)). Both of the sequences (c₁(t) and c₂(t) ) will obtain a diversity gain.

The benefits of the present invention may also be understood from simulation results. FIG. 11 illustrates Packet Error Rate (PER) and Bite Error Rate (BER) for 18 Mbps transmission. For a proper comparison, 2×3 with QPSK, with a coding rate of ¾ (18 Mbps) is also added. According to embodiments of the present invention, the data rate is 1.5*2 (bits/tone)*½(coding rate)*48(tones/symbol)*¼(symbol/μsec)=18 Mbps. It is noted that the data rates are increased by 1.5. The broken lines show PER and the solid lines show BER. The plot illustrates the processes of the present invention are better with a diversity gain.

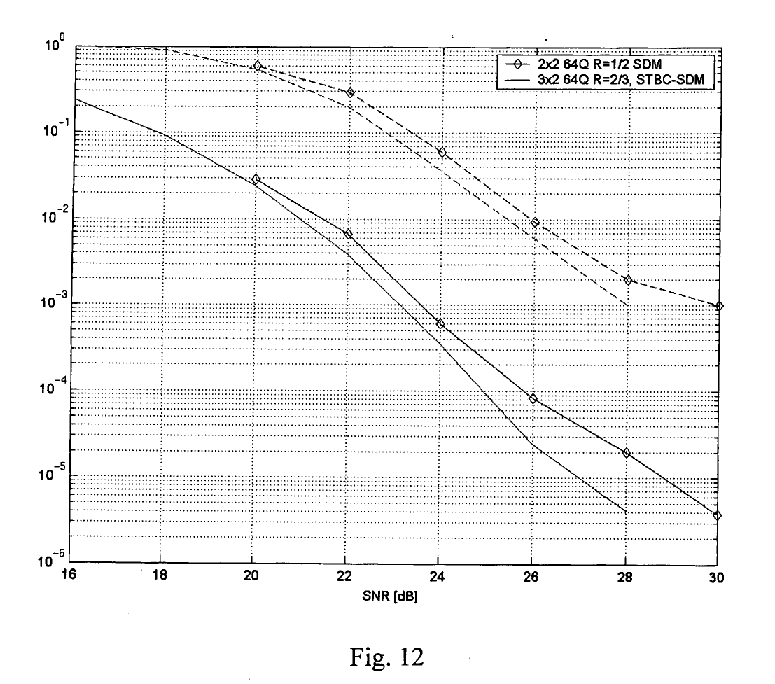

FIG. 12 illustrates PER and BER for 72 Mbps transmission. For a proper comparison, 2×2 with 64QAM, with a coding rate of ½ (72 Mbps) is also added. According to embodiments of the present invention, the data rate is 1.5*6 (bits/tone)*⅔(coding rate)*48(tones/symbol)*¼ (symbol/μsec)=72 Mbps. It is noted that the data rates are increased by 1.5. The broken lines show PER and the solid lines show BER. The plot illustrates the processes of the present invention are better with a diversity gain.

Although the invention has been described based upon these preferred embodiments, it would be apparent to those skilled in the art that certain modifications, variations, and alternative constructions would be apparent, while remaining within the spirit and scope of the invention. In order to determine the metes and bounds of the invention, therefore, reference should be made to the appended claims.

1. A method of communicating data to M receiving antennas from N transmitting antennas, where M and N are integers, the method comprising the steps of:
producing N data streams from outbound data;
applying the N data streams to a space/time encoder to produce N encoded signals; and
transmitting the N encoded signals from N transmitting antennas;
wherein at least P transmitting antennas transmit space-time block-coded signals and (N-P) transmitting antennas transmit repetition code signals, where P is an integer.

2. The method of claim 1, wherein the step of transmitting the N encoded signals is performed such that the M receiving antennas receive at least three Orthogonal Frequency Division Multiplexing (OFDM) symbols per tone.

3. The method of claim 1, wherein P comprises two and the step of transmitting the N encoded signals comprises transmitting two space-time block-coded signals over two transmit antennas.

4. The method of claim 3, wherein N comprises three and the step of transmitting the N encoded signals comprises transmitting a repetition code signal over one transmit antenna.

5. A method according to claim 1, wherein the step of applying the N data streams to a space/time encoder is performed such that the outbound data is reconstituted by zero-forcing terms equivalent to relationships between signals sent from the N transmitting antennas to the M receiving antennas to cancel interference.

6. A method according to claim 5, wherein the relationships comprise:
$$[ \begin{matrix}{r}_{1} \\ {r}_{2}\end{matrix} ] = [ \begin{matrix}{H}_{1} & {G}_{1} \\ {H}_{2} & {G}_{2}\end{matrix} ] [ \begin{matrix}{c}_{1} \\ {c}_{2}\end{matrix} ] + [ \begin{matrix}{n}_{1} \\ {n}_{2}\end{matrix} ] \qquad where ,$$
$${c}_{1} = [ \begin{matrix}{c}_{1} ( {t}_{0} ) \\ {c}_{1} ( {t}_{1} )\end{matrix} ] , \qquad {c}_{2} = [ {c}_{2} ( {t}_{0} ) ] , \qquad {r}_{1} = [ \begin{matrix}{r}_{1} ( {t}_{1} ) \\ {r}_{1}^{*} ( {t}_{2} )\end{matrix} ] , \qquad {r}_{2} = [ \begin{matrix}{r}_{2} ( {t}_{1} ) \\ {r}_{2}^{*} ( {t}_{2} )\end{matrix} ] ,$$
$${H}_{i} = [ \begin{matrix}{h}_{1 i} & {h}_{2 i} \\ {h}_{2 i}^{*} & - {h}_{1 i}^{*}\end{matrix} ] , \qquad {G}_{i} = [ \begin{matrix}{g}_{i} \\ {g}_{i}^{*}\end{matrix} ] ,$$
where rᵢ(t) and cᵢ(t) are the received and transmitted signals, respectively, nᵢ represent noise terms and Gᵢ and Hᵢ represent relationships between signals sent from the N transmitting antennas to the M receiving antennas.

7. The method of claim 6, wherein the cancellation of the interference through zero forcing comprises:
$$\begin{matrix}\begin{matrix}{[ \begin{matrix}[ \begin{matrix}1 & 0 \\ 0 & 1\end{matrix} ] & [ \begin{matrix}- {g}_{1} {g}_{2}^{- 1} & 0 \\ 0 & - {g}_{1}^{*} {g}_{2}^{- 1 *}\end{matrix} ] \\ a b & c d\end{matrix} ]}_{3 \times 4} \times [ \begin{matrix}{r}_{1} \\ {r}_{2}\end{matrix} ] = [ \begin{matrix}{\tilde{r}}_{1} \\ {\tilde{r}}_{2}\end{matrix} ] \\ = {[ \begin{matrix}\tilde{H} & 0 \\ 0 & \tilde{G}\end{matrix} ]}_{3 \times 3} \times [ \begin{matrix}{c}_{1} \\ {c}_{2}\end{matrix} ] + [ \begin{matrix}{\tilde{n}}_{1} \\ {\tilde{n}}_{2}\end{matrix} ]\end{matrix} \\ \begin{matrix}where , {\tilde{H}}_{2 \times 2} = {H}_{1} - [ \begin{matrix}- {g}_{1} {g}_{2}^{- 1} & 0 \\ 0 & - {g}_{1}^{*} {g}_{2}^{- 1 *}\end{matrix} ] \times {H}_{2} , & {\tilde{G}}_{1 \times 1} = {\vert {g}_{1} \vert}^{2} + {\vert {g}_{2} \vert}^{2} ,\end{matrix}\end{matrix}$$
and a, b, c, d satisfy the following equation,
$$[ \begin{matrix}a \\ b \\ c \\ d\end{matrix} ] = {[ \begin{matrix}{h}_{11} & {h}_{21}^{*} & {h}_{12} & {h}_{22}^{*} \\ {h}_{21} & - {h}_{11}^{*} & {h}_{22} & - {h}_{12}^{*} \\ {g}_{1} & {g}_{1}^{*} & 0 & 0 \\ 0 & 0 & {g}_{2} & {g}_{2}^{*}\end{matrix} ]}^{- 1} \times [ \begin{matrix}0 \\ 0 \\ {\vert {g}_{1} \vert}^{2} \\ {\vert {g}_{2} \vert}^{2}\end{matrix} ] .$$

8. The method of claim 1, wherein P=(⅔)*N and the step of transmitting the N encoded signals comprises transmitting P space-time block-coded signals through P transmit antennas.

9. A transmitter for communicating data from N transmitting antennas to M receiving antennas, where M and N are integers, comprising:
streaming means for producing N data streams from outbound data;
encoding means for applying the N data streams to a space/time encoder to produce N encoded signals; and
N transmit antenna means for transmitting N encoded signals to M receiving antennas;
wherein the encoding means provides at least P space-time block-coded signals to P transmit antenna means and provides (N-P) repetition code signals to (N-P) transmit antennas, where P is an integer.

10. The transmitter of claim 9, wherein the encoding means is configured to provide the N encoded signals such that the M receiving antennas receive at least three Orthogonal Frequency Division Multiplexing (OFDM) symbols per tone.

11. The transmitter of claim 9, wherein P comprises two and the transmitting means transmit two space-time block-coded signals over two transmit antennas.

12. The transmitter of claim 11, wherein N comprises three and the transmitting means transmit a repetition code signal over one transmit antenna.

13. A transmitter according to claim 9, wherein the encoding means is configured to encode the N data streams such that the outbound data is reconstituted by zero-forcing terms equivalent to relationships between signals sent from the N transmitting antennas to the M receiving antennas to cancel interference.

14. A transmitter according to claim 13, wherein the relationships comprise:
$$[ \begin{matrix}{r}_{1} \\ {r}_{2}\end{matrix} ] = [ \begin{matrix}{H}_{1} & {G}_{1} \\ {H}_{2} & {G}_{2}\end{matrix} ] [ \begin{matrix}{c}_{1} \\ {c}_{2}\end{matrix} ] + [ \begin{matrix}{n}_{1} \\ {n}_{2}\end{matrix} ] \qquad where ,$$
$${c}_{1} = [ \begin{matrix}{c}_{1} ( {t}_{0} ) \\ {c}_{1} ( {t}_{1} )\end{matrix} ] , \qquad {c}_{2} = [ {c}_{2} ( {t}_{0} ) ] , \qquad {r}_{1} = [ \begin{matrix}{r}_{1} ( {t}_{1} ) \\ {r}_{1}^{*} ( {t}_{2} )\end{matrix} ] , \qquad {r}_{2} = [ \begin{matrix}{r}_{2} ( {t}_{1} ) \\ {r}_{2}^{*} ( {t}_{2} )\end{matrix} ] ,$$
$${H}_{i} = [ \begin{matrix}{h}_{1 i} & {h}_{2 i} \\ {h}_{2 i}^{*} & - {h}_{1 i}^{*}\end{matrix} ] , \qquad {G}_{i} = [ \begin{matrix}{g}_{i} \\ {g}_{i}^{*}\end{matrix} ] ,$$
where rᵢ(t) and cᵢ(t) are the received and transmitted signals, respectively, nᵢ represent noise terms and Gᵢ and Hᵢ represent relationships between signals sent from the N transmitting antennas to the M receiving antennas.

15. The transmitter of claim 14, wherein the cancellation of the interference through zero forcing comprises:
$$\begin{matrix}\begin{matrix}{[ \begin{matrix}[ \begin{matrix}1 & 0 \\ 0 & 1\end{matrix} ] & [ \begin{matrix}- {g}_{1} {g}_{2}^{- 1} & 0 \\ 0 & - {g}_{1}^{*} {g}_{2}^{- 1 *}\end{matrix} ] \\ a b & c d\end{matrix} ]}_{3 \times 4} \times [ \begin{matrix}{r}_{1} \\ {r}_{2}\end{matrix} ] = [ \begin{matrix}{\tilde{r}}_{1} \\ {\tilde{r}}_{2}\end{matrix} ] \\ = {[ \begin{matrix}\tilde{H} & 0 \\ 0 & \tilde{G}\end{matrix} ]}_{3 \times 3} \times [ \begin{matrix}{c}_{1} \\ {c}_{2}\end{matrix} ] + [ \begin{matrix}{\tilde{n}}_{1} \\ {\tilde{n}}_{2}\end{matrix} ]\end{matrix} \\ \begin{matrix}where , {\tilde{H}}_{2 \times 2} = {H}_{1} - [ \begin{matrix}- {g}_{1} {g}_{2}^{- 1} & 0 \\ 0 & - {g}_{1}^{*} {g}_{2}^{- 1 *}\end{matrix} ] \times {H}_{2} , & {\tilde{G}}_{1 \times 1} = {\vert {g}_{1} \vert}^{2} + {\vert {g}_{2} \vert}^{2} ,\end{matrix}\end{matrix}$$
and a, b, c, d satisfy the following equation,
$$[ \begin{matrix}a \\ b \\ c \\ d\end{matrix} ] = {[ \begin{matrix}{h}_{11} & {h}_{21}^{*} & {h}_{12} & {h}_{22}^{*} \\ {h}_{21} & - {h}_{11}^{*} & {h}_{22} & - {h}_{12}^{*} \\ {g}_{1} & {g}_{1}^{*} & 0 & 0 \\ 0 & 0 & {g}_{2} & {g}_{2}^{*}\end{matrix} ]}^{- 1} \times [ \begin{matrix}0 \\ 0 \\ {\vert {g}_{1} \vert}^{2} \\ {\vert {g}_{2} \vert}^{2}\end{matrix} ] .$$

16. The transmitter of claim 9, wherein P=(⅔)*N and N transmit antenna means transmitting P space-time block-coded signals through P transmit antennas.

17. A transmitter for communicating data from N transmitting antennas to M receiving antennas, where M and N are integers, comprising:
a demultiplexer, configured to provide N data streams from outbound data;
a space/time encoder, configured to receive the N data streams and supply N encoded signals; and
N transmit antennas, configured to transmit the N encoded signals;
wherein the space/time encoder provides at least P space-time block-coded signals to P transmit antenna means and provides (N-P) repetition code signals to (N-P) transmit antennas, where P is an integer.

18. The transmitter of claim 17, wherein the space/time encoder is configured to provide the N encoded signals such that the M receiving antennas receive at least three Orthogonal Frequency Division Multiplexing (OFDM) symbols per tone.

19. The transmitter of claim 17, wherein P comprises two and the space/time encoder is configured to provide two space-time block-coded signals to two transmit antennas.

20. The transmitter of claim 19, wherein N comprises three and the space/time encoder is configured to provide a repetition code signal to one transmit antenna.

21. A transmitter according to claim 17, wherein the space/time encoder is configured to encode the N data streams such that the outbound data is reconstituted by zero-forcing terms equivalent to relationships between signals sent from the N transmitting antennas to the M receiving antennas to cancel interference.

22. A transmitter according to claim 21, wherein the relationships comprise:
$$[ \begin{matrix}{r}_{1} \\ {r}_{2}\end{matrix} ] = [ \begin{matrix}{H}_{1} & {G}_{1} \\ {H}_{2} & {G}_{2}\end{matrix} ] [ \begin{matrix}{c}_{1} \\ {c}_{2}\end{matrix} ] + [ \begin{matrix}{n}_{1} \\ {n}_{2}\end{matrix} ] \qquad where ,$$
$${c}_{1} = [ \begin{matrix}{c}_{1} ( {t}_{0} ) \\ {c}_{1} ( {t}_{1} )\end{matrix} ] , \qquad {c}_{2} = [ {c}_{2} ( {t}_{0} ) ] , \qquad {r}_{1} = [ \begin{matrix}{r}_{1} ( {t}_{1} ) \\ {r}_{1}^{*} ( {t}_{2} )\end{matrix} ] , \qquad {r}_{2} = [ \begin{matrix}{r}_{2} ( {t}_{1} ) \\ {r}_{2}^{*} ( {t}_{2} )\end{matrix} ] ,$$
$${H}_{i} = [ \begin{matrix}{h}_{1 i} & {h}_{2 i} \\ {h}_{2 i}^{*} & - {h}_{1 i}^{*}\end{matrix} ] , \qquad {G}_{i} = [ \begin{matrix}{g}_{i} \\ {g}_{i}^{*}\end{matrix} ] ,$$
where rᵢ(t) and cᵢ(t) are the received and transmitted signals, respectively, nᵢ represent noise terms and Gᵢ and Hᵢ represent relationships between signals sent from the N transmitting antennas to the M receiving antennas.

23. The transmitter of claim 22, wherein the cancellation of the interference through zero forcing comprises:
$${[ \begin{matrix}[ \begin{matrix}1 & 0 \\ 0 & 1\end{matrix} ] & [ \begin{matrix}- {g}_{1} {g}_{2}^{- 1} & 0 \\ 0 & - {g}_{1}^{*} {g}_{2}^{- 1 *}\end{matrix} ] \\ a b & c d \end{matrix} ]}_{3 \times 4} \times [ \begin{matrix}{r}_{1} \\ {r}_{2}\end{matrix} ] = [ \begin{matrix}{\tilde{r}}_{1} \\ {\tilde{r}}_{2}\end{matrix} ] = {[ \begin{matrix}\tilde{H} & 0 \\ 0 & \tilde{G}\end{matrix} ]}_{3 \times 3} \times [ \begin{matrix}{c}_{1} \\ {c}_{2}\end{matrix} ] + [ \begin{matrix}{\tilde{n}}_{1} \\ {\tilde{n}}_{2}\end{matrix} ] where , {\tilde{H}}_{2 \times 2} = {H}_{1} - [ \begin{matrix}- {g}_{1} {g}_{2}^{- 1} & 0 \\ 0 & - {g}_{1}^{*} {g}_{2}^{- 1 *}\end{matrix} ] \times {H}_{2} , {\tilde{G}}_{1 \times 1} = {\vert {g}_{1} \vert}^{2} + {\vert {g}_{2} \vert}^{2} ,$$
and a, b, c, d satisfy the following equation,
$$[ \begin{matrix}a \\ b \\ c \\ d\end{matrix} ] = {[ \begin{matrix}{h}_{11} & {h}_{21}^{*} & {h}_{12} & {h}_{22}^{*} \\ {h}_{21} & - {h}_{11}^{*} & {h}_{22} & - {h}_{12}^{*} \\ {g}_{1} & {g}_{1}^{*} & 0 & 0 \\ 0 & 0 & {g}_{2} & {g}_{2}^{*}\end{matrix} ]}^{- 1} \times [ \begin{matrix}0 \\ 0 \\ {\vert {g}_{1} \vert}^{2} \\ {\vert {g}_{2} \vert}^{2}\end{matrix} ] .$$

24. The transmitter of claim 17, wherein P=(⅔)*N and N transmit antennas transmitting P space-time block-coded signals through P transmit antennas.
